(19) United States
(12) Patent Application Publication
(10) Pub. No.: US 2017/0300984 A1
(43) Pub. Date: Oct. 19, 2017

(54) PLATFORM FOR PREDICTION OF CONSUMPTION AND RE-ORDERING OF GOODS

(71) Applicant: Agalmic Inc., San Francisco, CA (US)

(72) Inventor: Jordan Hurwich, San Francisco, CA (US)

(73) Assignee: Agalmic Inc., San Francisco, CA (US)

(21) Appl. No.: 15/490,681

(22) Filed: Apr. 18, 2017

Related U.S. Application Data
(60) Provisional application No. 62/324,452, filed on Apr. 19, 2016.

(51) Int. Cl. G06Q 30/06; G06Q 10/08

(52) U.S. Cl. CPC G06Q 30/0601; G06Q 10/087

(57) ABSTRACT

A method includes a tracking unit with a sensor, a microcontroller, and a transmitter. Data of a good is collected indicating an amount of the good. The data is transmitted to a backend. The backend calculates a depletion rate, a threshold value, a depletion point, a predicted shipping time and a reorder point. The depletion rate indicates a rate of consumption of the good. The threshold value indicates an empty weight of the good. The depletion point indicates a time when the good will be depleted based on the threshold value, the depletion rate and a current amount of the good. The reorder point is based on the depletion point and the predicted shipping time. At the reorder point, the backend conducts a reverse auction request for a cost quote to order the good. The backend determines a lowest cost quote and orders the good with the lowest cost quote.

### RELATED APPLICATIONS

The application claims the benefit of U.S. Provisional Patent Application No. 62/324,452 filed on Apr. 19, 2016 and entitled “Platform for Prediction of Consumption and Re-Ordering of Goods”, which is hereby incorporated by reference for all purposes.

### BACKGROUND

Many consumers feel inconvenienced when having to purchase household consumable items at retail stores. Instead, consumers choose to shop online and may place orders via the Internet. While Internet shopping is substantially more convenient than in-person shopping at the retail store, it still involves a significant amount of time and inconvenience. For example, the consumer must determine which items are to be ordered, make a list, shop for those items, and then place the order. Moreover, it will be appreciated that ordering typically occurs when such items are completely depleted from household inventory forcing consumers to go without a consumable item before it can be purchased or requiring them to plan for depletion and maintain a stockpile of replacements.

Automated inventory systems for facilitating the replenishment of goods, particularly at manufacturing and wholesale facilities, are well known in the art. In some systems, sensors may be used for detecting the presence of desired inventory items, and a processor may be used for facilitating restocking of those items whose stock level has fallen below a predetermined level. The ordering process typically involves some manual request or input from the user and the orders are eventually placed with one, fixed supplier. In this way, the orders may not be fulfilled by the lowest priced supplier.

Systems to submit orders or subscribe to ordering a good by a user are also known in the art. Some automatic ordering systems on the market are subscription based which may order a good on a routine schedule, such as monthly, regardless of the inventory used. Typically, special hardware components are not needed and the consumption of the good by the user is not known. Other systems exist which include a hardware component to minimize the effort required to place an order. In both of these types of systems, user action is required that is merely simplified through hardware. One such example may be an option on a merchant website to select a pre-programmed button to order a specified good. Another example may be a voice-activated system that may place orders based on a verbal command from the user.

### SUMMARY

A method is disclosed that includes providing a tracking unit configured with a sensor, a microcontroller coupled to the sensor, and a transmitter coupled to the microcontroller. Data of a good associated with a user may be collected by the microcontroller from the sensor. The data of the good is indicative of an amount of the good. The data of the good is transmitted by the transmitter through a device that relays the data of the good to a backend. The backend receives the data of the good and calculates a depletion rate of the good, a threshold value of the good, a depletion point, a predicted shipping time to receive the good and a reorder point. The depletion rate indicates a rate of consumption of the good by the user based on the data of the good. The threshold value indicates an empty weight of the good. The depletion point indicates a time when the good will be depleted based on the threshold value and the depletion rate and a current value of the data of the good. The reorder point is based on the depletion point and the predicted shipping time to receive the good. At the reorder point, the backend conducts a reverse auction request to a fulfillment source for a cost quote to order the good. The backend receives the cost quote from the fulfillment source and determines a lowest cost quote of the good. The backend transmits a notification to a user device associated with the user and orders the good on behalf of the user from the fulfillment source with the lowest cost quote.

### BRIEF DESCRIPTION OF THE DRAWINGS

FIG. 1 is a simplified schematic of an environment for the method, system or platform in accordance with some embodiments;

FIG. 2 is an exploded view of a tracking unit in accordance with some embodiments;

FIG. 3 depicts a simplified reference design table of tracking unit examples in accordance with some embodiments;

FIG. 4 shows examples of a platform weight scale reference design accordance with some embodiments;

FIG. 5 illustrates an exploded view of a platform weight scale in accordance with some embodiments;

FIG. 6 depicts a platform weight scale reference design in accordance with some embodiments;

FIG. 7 shows a smart feet weight scale reference design in accordance with some embodiments;

FIGS. 8A and 8B illustrate smart feet in accordance with some embodiments;

FIG. 9A shows a perspective view of a smart foot in accordance with some embodiments;

FIG. 9B illustrates an exploded view of the smart foot shown in FIG. 9A in accordance with some embodiments;

FIG. 9C shows a reference design of a tracking unit as a smart foot in accordance with some embodiments;

FIG. 10 is a hanging weight scale reference design in accordance with some embodiments;

FIG. 11A is a tracking unit as an inline pressure sensor assembly reference design in accordance with some embodiments;

FIG. 11B is a cutaway view of the tracking unit shown in FIG. 11A in accordance with some embodiments;

FIG. 11C is an exploded view of the tracking unit shown in FIG. 11A in accordance with some embodiments;

FIG. 11D is an exploded view of the tracking unit shown in FIG. 11A with a pressure vessel assembly, in accordance with some embodiments;

FIGS. 12A and 12B show a method, system or platform in accordance with some embodiments;

FIGS. 13 and 14 are simplified flowcharts of a method, system or platform for the prediction of consumption and reordering of goods in accordance with some embodiments;

FIGS. 15 and 16 show graphs that illustrate the calculation and the prediction of depletion in accordance with some embodiments;

FIGS. 17A-17C illustrate simplified graphs of a method in accordance with some embodiments;

FIG. 18 demonstrates a method in accordance with some embodiments;

FIG. 19 illustrates a simplified table of results of a reverse auction in accordance with some embodiments;

FIG. 20 is a simplified schematic of the method, system or platform in accordance with some embodiments;

FIG. 21 is a simplified flowchart of the confirmation inquiry of the method, system or platform in accordance with some embodiments;

FIG. 22 depicts a simplified flowchart for aggregating orders of the method, system or platform in accordance with some embodiments;

FIG. 23 are example advertisements in accordance with some embodiments;

FIG. 24 is a simplified schematic of an advertisement by the fulfillment source accordance with some embodiments; and

FIG. 25 is a simplified flowchart for a method for the prediction of consumption and reordering of goods in accordance with some embodiments.

### DETAILED DESCRIPTION

A method and system are described herein that, unlike the above described prior art, measure actual consumption of an item to predict depletion of the item so as to enable a demand driven platform for the prediction of consumption and reordering of goods. The method includes providing a tracking unit configured with a sensor, a microcontroller coupled to the sensor, and a transmitter coupled to the microcontroller. Data of a good associated with a user is collected by the microcontroller from the sensor. The data of the good is indicative of an amount of the good, in units of weight, volume, pressure, or count. The data of the good is transmitted by the transmitter through a device that relays the data of the good to a computerized system, referred to herein as a “backend.” The backend receives the data of the good and calculates a depletion rate of the good, a threshold value of the good, a depletion point, a predicted shipping time to receive the good and a reorder point. The depletion rate indicates a rate of consumption of the good by the user based on the data of the good. The threshold value indicates an empty weight of the good. The depletion point indicates a time when the good will be depleted based on the threshold value and the depletion rate and a current value of the data of the good. The reorder point is based on the depletion point and the predicted shipping time to receive the good. At the reorder point, the backend conducts a reverse auction request to one or more fulfillment sources for cost quotes to order the good. The backend receives the cost quotes from the fulfillment sources and determines a lowest cost quote of the good. The backend transmits a notification to a user device associated with the user and orders the good on behalf of the user from the fulfillment source with the lowest cost quote.

In some embodiments, the tracking unit is coupled to the good and associated with the good before a sale of the good to the user. In further embodiments, the tracking unit is coupled to an appliance and associated with the good in the appliance after a sale of the good. The tracking unit may be coupled to a pad and the pad may be capable of being associated with one or more goods after the sale of the good. The data of the good is a weight, volume, pressure, or count of the good.

The method further includes transmitting by the backend, an alert to the user if there is no change in the data of the good in a predetermined timeframe.

In some embodiments, the sensor is a pressure sensor or a strain gauge. A plurality of tracking units each having a different type of sensor collects the data of the good or the data of a plurality of goods. The data may be transmitted by WiFi, Bluetooth or cellular technology. The device may be a router, smartphone, hub or cellular network transceiver.

In some embodiments, the notification suggests alternative brands of the good to order with incentives for the fulfillment source. The incentives for the fulfillment source may be a reduced referral fee or a cease of alternative brand suggestions. In some embodiments, the reorder point is further based on a buffer. The buffer may be a buffer time (e.g., a number of days optionally based at least in part on the predicted shipping time) and/or a buffer weight (e.g., indicating a minimum amount of the good above the empty weight). Thus, the calculation for the reorder point may be based on the predicted shipping time plus the buffer time (number of days), or the reorder point or depletion point may be based on a threshold value which is, in turn, based on a buffer weight, which is the minimum amount of the good above the empty weight. In this manner, the arrival of the ordered good is ensured to be some appropriate period of time (e.g., number of days) prior to the day or time at which the user runs out of the good.

In some embodiments, a method for the prediction of consumption and reordering of goods includes providing a tracking unit. The tracking unit is configured with a sensor, a microcontroller coupled to the sensor, and a transmitter coupled to the microcontroller. Data of a good is collected by the microcontroller from the sensor. The good is associated with a user and the data of the good is indicative of an amount of the good. The transmitter transmits the data of the good through a device that relays the data of the good to a backend. The backend receives the data of the good and calculates a depletion rate of the good, a threshold value of the good, a depletion point, a predicted shipping time to receive the good and a reorder point. The depletion rate indicates a rate of consumption of the good by the user based on the data of the good. The threshold value indicates an empty weight of the good. The depletion point indicates a time when the good will be depleted based on the threshold value and the depletion rate and a current value of the data of the good. The reorder point is based on the depletion point and the predicted shipping time to receive the good. At the reorder point, the backend transmits a request to a fulfillment source for a cost quote to order the good. The backend transmits a notification to a user device associated with the user. The backend orders the good on behalf of the user from the fulfillment source. The depletion rate indicates a rate of consumption of the good by the user based on the data of the good. The fulfillment source pays a premium. The premium is a fee.

In some embodiments, the tracking unit may be restricted to a specific good and attached to the good before sale of the good to the user. In some examples, this may be a bag of Brand A coffee beans that automatically reorders that same flavor of Brand A coffee beans. In another embodiment, the tracking unit is coupled to an appliance and associated with the good in the appliance after a sale of the good. For example, the tracking unit may be configured to be coupled to reorder a specific good or type of good, but attached to another appliance or good which is then sold to the user. In some embodiments, the user may program the tracking unit to reorder a specific good amongst a restricted type of goods, e.g. choosing flavor amongst a set of options from the same consumable brand, or the restriction may limit the user to a single, specific good and prevent choice. An example of this may be a Brand A coffee grinder or jar that reorders Brand A coffee beans of any chosen available flavor. In a further embodiment, the tracking unit may be configured without restrictions on the good or type of good and attached to another appliance or product which the user may program to track and reorder the specific good of his/her choice. For example, this may be a coffee grinder or jar from an unaffiliated brand appliance company that can reorder coffee beans of any available brand or flavor.

The method, system or platform described herein enables prediction of the depletion of a good by monitoring the change of a good through a tracking unit. The tracking unit may be built and sold by a manufacturer or a fulfillment source and may be integrated in or coupled to the good. The tracking unit may be pre-programmed before the sale of the good to the user or may be generic or not programmed before the sale of the good enabling a user to program the tracking unit with the selected good.

The method, system or platform may enable configuration of the tracking unit by the manufacturer potentially scoping and limiting the tracking-enabled good before sale to the consumer. This may include pre-configuring the type and/or brand of replacement goods ordered by that tracking unit, or enabling unique, developed functionality for that product. In some embodiments, this may be achieved by publishing a flexible reference design for manufacturer to complete and integrate into the form factor of their choice with their desired components, by providing configurable proprietary firmware for tracking units built according to the reference design (e.g., with or without charge to those manufacturers), and by providing access to protected server APIs (e.g., operating on the server backend) to access data and enable expanded server-side functionality. The provided firmware, by default, transmits sensor data to a central (e.g., cloud-based) backend that provides valuable services based on the data. In some embodiments, the manufacturer may expand or configure this functionality by configuring the firmware, but may not redirect transmission to an alternative server backend. Manufacturers may be provided access to the server backend through defined APIs, which may be limited to receiving data from and acting upon data transmitted from tracking units developed by that manufacturer.

Both the firmware and server may provide greater flexibility to manufacturers during development, allowing communication between any development firmware and an example backend populated with mock data without prior approval. However, the manufacturer cannot use the development firmware or server for any unit intended for sale, and must seek approval from the method, system or platform before any new feature may be added to the production firmware and server. As such, the manufacturer must seek approval for any new tracking-enabled good indicating all changes including components selected, firmware modifications, and any server APIs used or which need to be developed. These may be reviewed and, if approved, enabled for the manufacturer by commissioning a set of unique IDs which the manufacturer may program into each unit of the approved type. The requested, expanded functionality may then be enabled for units with those IDs, or for all units, as desired.

“Imposter” units which may have stolen firmware or otherwise unapproved implementations, and thus contain no approved ID, will not function because their unique ID is not recognized and approved by the server backend. Likewise, IDs may be revoked, thus disabling any active unit as necessary.

In another embodiment, the backend may support a plurality of reference designs, such as using signals containing data of the good other than weight. When the good being tracked is near depletion, the method, system or platform supports seamless reordering which may be with or without user confirmation from the lowest cost quote from the fulfillment source. In some embodiments, the fulfillment source may pay a negotiated referral fee to the method, system or platform for orders. This fee may be shared with the manufacturer. In another embodiment, the fulfillment source may pay a premium for the good to be ordered from the fulfillment source regardless of the lowest cost quote. The premium is a fee. In this way, the fulfillment source may pay a fee to the method, system or platform to avoid competitive bidding. The fulfillment source is committed as the source for the good to be shipped to the user.

In some embodiments, data of the good and consumption patterns of the good may be used to support an advertisement platform. For example, advertisements for a different brand of the good type may appear in notifications when the user is reminded about upcoming depletions. The user may select the advertisement and be subscribed to that particular brand of the good the next time the good is ordered.

Many purchases by consumers are the result of consumption based behavior, for example, buying new toilet paper after using the last roll of toilet paper is used. The method, system or platform monitors the consumption, and thus the need to reorder the good or product may be predicted based on the actual, current consumption trend. This may be accomplished by enabling prediction of any good's depletion by tracking or monitoring the change in the amount of a good through tracking units.

The method, system or platform offers cloud services, like tracking and monitoring the consumable good based on sensor data and reordering the consumable good. A reference design is provided that manufacturers may embody with their own components instead of selling specific integrated units. The method, system or platform may use “one-way” communication mechanisms like Bluetooth® Low Energy broadcasts, which communicate with an application on a smartphone (or other appropriate communication relay device) to receive and relay these broadcasts to the server backend, thereby enabling battery-powered, small and inexpensive tracking units. The method, system or platform may also support two-way communication mechanisms like WiFi and cellular connections to the Internet, e.g., in cases where the tracking unit is not powered by a battery and/or when the server backend must be able to affect or otherwise communicate with the tracking unit.

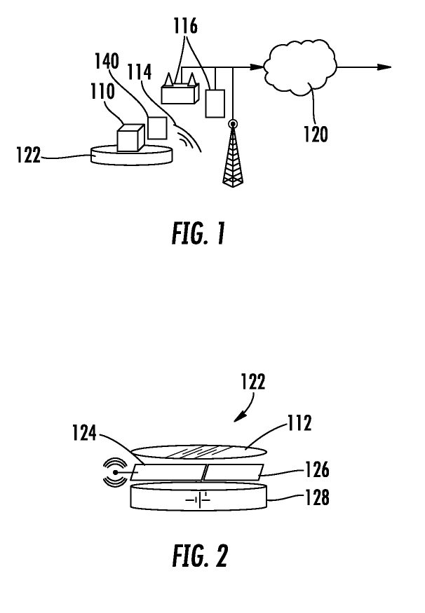

FIG. 1 is a simplified schematic of an example environment for the method, system or platform in accordance with some embodiments. The mechanics of using, for example, data of the good, to predict depletion of a consumable good 110 and trigger the ordering process is described. A tracking unit 122 (using one or more sensors, and being associated with the good 110) generates sensor data 140 for the consumable good 110. The data 140 of the good 110 is indicative of an amount of the good 110. The data 140 of the good 110 may be or indicate a weight, volume, pressure, or count of the good. In some embodiments, the tracking unit 122 detects a change in the sensor data 140 (or in the amount of the good 110 based on the change in the sensor data 140). The change in data 140 or the amount of the good 110 prompts transmission of a current value for the sensor data 140. The transmitting of the data 140 may be achieved through communication technologies 114 such as a WiFi system, Bluetooth® wireless technology, Bluetooth® Low Energy, cellular communications, satellite communications or the like, as well as combinations thereof. A device 116 (such as a router, smartphone, hub, cellular network transceiver or the like or combinations thereof) receives the data 140 and relays it to a backend 120. The backend 120 is configured through a server 118 and may include a server 118 or a computer with access to an internal database and external databases. In other embodiments, the backend 120 may be cloud-based, a standalone server, a server farm, or one or more separate computing devices. The backend 120 converts the data 140 to information, and records or stores the information, updates the consumption trend, and then uses the current data 140 and consumption trend to calculate an anticipated depletion date. For items or goods 110 for which depletion is expected within a certain timeframe, for example, in the next week (and taking into account a required shipping time to receive the good 110), the backend 120 triggers a notification to the user (through a user device), initiates a reverse auction process, and/or automatically orders the good 110 from the fulfillment source.

In some embodiments, the tracking unit 122 is integrated in or coupled to the good 110. FIG. 2 is an exploded view of an example of the tracking unit 122 in accordance with some embodiments. The tracking unit 122 is configured with a sensor or sensors 112, a radio or transmitter 124, a microcontroller 126 and a power supply 128. The microcontroller 126 is coupled to the sensor 112 and the transmitter 124. In some embodiments, the tracking unit 122 is built and/or sold by a manufacturer or reseller of the good 110 based on a published reference design. For each component of the tracking unit 122, a pre-approved list of components and a detailed set of performance requirements indicating the required quality for the component to be accepted may be published and maintained by an owner or operator of the method, system or platform. For an accepted component, a firmware software version is made available to the manufacturer or reseller that enables utilization of that component. There may also be published schematic requirements detailing how each component may be connected, which interface buses may be supported and in what configuration, so they may be recognized by the firmware.

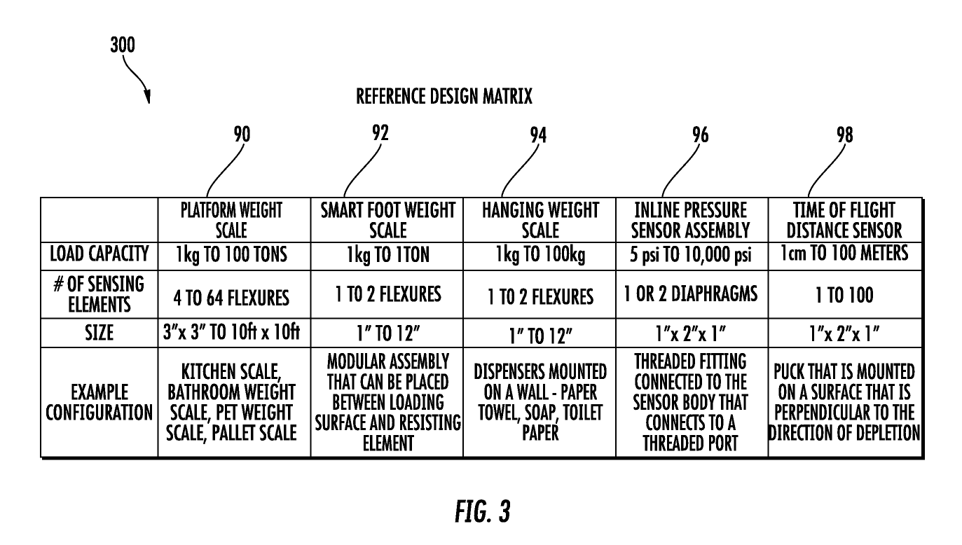

In some embodiments, the sensor 112 of the tracking unit 122 may be a pressure sensor, strain gauge or the like. A variety of pressure sensors and/or strain gauges may support a wide array of consumable goods 110 or product weights and measurement accuracies, and the manufacturers or resellers may select those that meet their expected use cases. FIG. 3 depicts a simplified reference design table 300 of tracking unit examples in accordance with some embodiments. In a non-limiting example, the table 300 details reference design examples (90-98) for the sensors 112 with respect to load capacity including the unit of measure, number of sensing elements, relative size of the tracking unit 122 and form factor combinations. The reference design examples generally include a platform weight scale 90, smart foot weight scale 92, hanging weight scale 94, inline pressure sensor assembly 96 and a time of flight distance sensor 98. In some embodiments, a plurality of tracking units 122, each having a different type of sensor 112, collects the data 140 of the good 110 or the data of a plurality of goods 110. In some embodiments, multiple tracking units 122 using the same or different sensor technologies are used to measure the single good 110 or multiple goods 110.

The data 140 of the good 110 from the sensor 112 is collected by the microcontroller 126. The data 140 is indicative of an amount of the good 110. The data 140 may be a weight, volume, pressure, or count of the good 110. The data 140 is transmitted by the transmitter 124 through the device 116 that relays the data 140 to the backend 120. Similarly, performance requirements are published for the microcontroller 126 and power supply 128, allowing manufacturers to select appropriate components that are supported by the method, system or platform. Reference designs for a variety of uplink methods of radio technology, e.g., incorporating the types of the communication technologies 114 described above, generally provide radio performance and battery life expectations for each.

Depending on the communication technologies 114 selected, the uplink path may differ. For example, for WiFi systems or cellular communications, the transmitter 124 of the tracking unit 122 may upload the data 140 or measurements directly to the backend 120 over the Internet using normal IP methods. For Bluetooth® Low Energy broadcasts, the data 140 or measurements may be received by another local device such as a smartphone or dedicated Bluetooth®-to-WiFi hub and uploaded from that device 116.

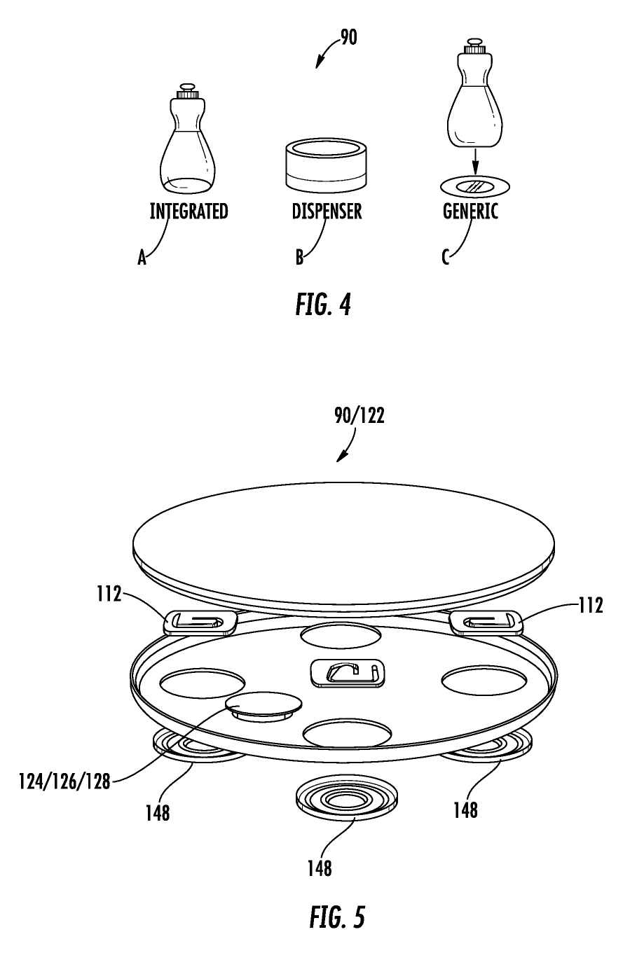

In some embodiments, the tracking unit 122 is integrated in or coupled to the good 110. FIG. 4 shows the platform weight scale 90 reference design, examples A, B, and C in accordance with some embodiments. For example, the platform weight scale 90 reference design of the tracking unit 122 may include the tracking unit 122 integrated in the good 110, coupled to a dispenser or it may be generic. In example A, the tracking unit 122 is integrated in the good 110. The tracking unit 122 may also be coupled to and associated with the good 110 before sale of the good 110 to the user. In this way, the tracking unit 122 is included in the good 110 or product before sale such as in the container of a soap container as illustrated in FIG. 4 as example A. In this case, the tracking unit 122 may be pre-programmed with the specific brand of the good 110 to be monitored and reordered.

The tracking unit 122 may be pre-programmed by the manufacturer before the sale of the good 110. This limits (particularly in the software) the design of the tracking unit 122. For example, this may limit the tracking unit 122 to a specific type of good 110 such as coffee beans for a coffee grinder, or a specific brand of the good 110. Manufacturers may use published flexible reference design requirements when integrating the tracking unit 122 into the form factor of their choice. The manufacturers may be provided with free configurable proprietary firmware for tracking units 122, access to protected server APIs to obtain data, and expanded server-side functionality. This may be free of charge to those manufacturers. The firmware operating through the transmitter and the relay device may transmit the sensor data 140 to the backend 120, which provides valuable services to the manufacturer. In some embodiments, the data and services may be limited to the tracking units 122 of a specific manufacturer. Both the firmware and server 118 may provide more flexibility in hardware and software during development. During development, engineering support may be provided to manufacturer as their tracking units 122 and unique features are designed and refined.

In example B of the platform weight scale 90 reference design of the tracking unit 122, the tracking unit 122 is coupled to a dispenser. In this way, the tracking unit 122 may be coupled to an appliance, such as under the appliance, with a reservoir or container for dispensing the good 110 such as in a pet food bowl or a flour bin. In some embodiments, the tracking unit 122 is coupled to an appliance and associated with the good 110 in the appliance after a sale of the good 110. The user may select the brand or flavor of the good 110 from a set of options. In some cases, the consumable good 110 contains more product than will fit within the refillable basin such as liquid soap for a refillable soap dispenser, coffee for a coffee grinder or pet food for a pet food bowl. Therefore, the change in the data 140 in the basin may be measured for multiple refills until a reorder is needed.

In a third implementation of the platform weight scale 90 reference design of the tracking unit 122, the tracking unit 122 may be generic as shown in FIG. 4 as example C. In this way, the tracking unit 122 is coupled to or placed on a gridded pad 146 and the gridded pad 146 is capable of being associated with one or more goods 110 after the sale of the good 110. For example, the tracking unit 122 may be integrated or coupled to the gridded pad 146 or container. The tracking unit 122, a user device (e.g., personal computer, smartphone, etc.), or the backend 120 may be programmed with the good 110 to be monitored. Multiple independent tracking units 122 may be integrated into a single gridded pad 146 to support a variable number of goods 110. FIG. 5 depicts the platform weight scale 90 reference design, example C, in accordance with some embodiments. For example, multiple tracking units 122 may be placed across the gridded pad 146 in a grid with each tracking unit 122 monitoring weight for a subsection of the gridded pad 146. The multiple tracking units 122 report their measurements, or the data 140, independently, as with the discrete individual tracking units 122. The backend 120 may be aware of their relationship to one another and provides the intelligence to detect multiple goods 110 on the pad gridded 146. The gridded pad 146 may be a container, coaster, mat, plate, drawer organizer, shelf organizer or the like and of virtually any shape or size to fit the appropriate application.

FIG. 5 illustrates an exploded view of a platform weight scale 90 that includes one or more sensors 112 in accordance with some embodiments. As shown, this tracking unit 122 includes the sensor 112, the radio or transmitter 124, the microcontroller 126 and the power supply 128 which senses the data 140 of the good 110, for example, weight change of the good 110 and/or its contents, and transmits that data 140. In some embodiments, the platform weight scale 90 may be made from a composite material and injection molded with rubberized, water resistant bases 148 and positioned underneath the product to be tracked.

Multiple tracking units 122 may be configured to be coupled to the gridded pad 146 so that the gridded pad 146 may be capable of being associated with one or more goods 110 after sale of the good 110. In this implementation, each tracking unit 122 may report a unique ID with each measurement, and the location of each tracking unit 122 within the gridded pad 146 may be provided by the manufacturer for the backend 120. This enables the backend 120 to associate each measurement with the appropriate location on the gridded pad 146 once the measurements are received by the backend 120. The combined measurements for the entire gridded pad 146, therefore, may form a heat map of, for example, weight, allowing the backend 120 to identify discrete goods 110 even if their placement on the gridded pad 146 changes. This may be supported by tracking units 122 that measure no or less weight, establishing a bounded footprint for any good 110, and the pre-existing information of how many and which goods 110 are intended to be on the gridded pad 146. A smaller size of, and a smaller pitch in between, the tracking units 122 generally enables a finer ability to identify the type of the goods 110 placed on the gridded pad 146.

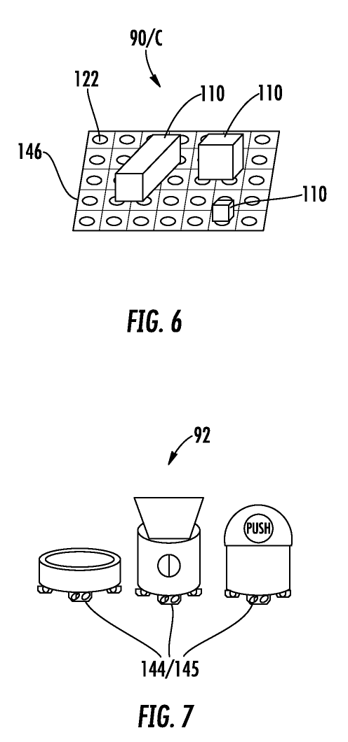

The generic implementations of example C, as a gridded pad 146 or container tracking one or multiple goods 110, enable users to program the tracking unit 122 with the selected good 110 being monitored. For example, a barcode of the good 110 may be scanned, a picture of the good 110 may be taken to programmatically identify the good 110, or a Mechanical Turk system may be utilized to associate the good 110 to the gridded pad 146. This may be accomplished running on a personal computer, smartphone, etc. Once the good 110 is associated to the gridded pad 146, the user may place the good 110 anywhere on the gridded pad 146 and the backend 120 will identify the locations of each good 110 to be tracked, if multiple, and update their current weight based on the sensor 112 data. FIG. 6 illustrates three different goods 110 on the gridded pad 146, such as a mat containing toothpaste, deodorant and moisturizer.

The known full weight and the known empty weight of the good 110 may establish bounds for reasonable measurements for that good 110. As well, the number of tracking units 122 activated when a given good 110 is on the gridded pad 146 may provide information about the footprint of a given good 110, which may further aid to identify the good 110 if it is moved upon the gridded pad 146 or replaced with a different good 110. The order in which the goods 110 are added and removed from the gridded pad 146 provides information to associate the measurement changes correctly and avoid confusion. For example, if the user just programmed a new good 110 or recently removed a previously programmed good 110, and a measurement change on the gridded pad 146 is detected, that change is most likely related to the new or removed good 110. Similarly, if a measured weight value or product footprint is not within the expectations for the previously programmed good 110, a warning may be shown to the user requesting correction of any errors or reprogramming the tracking unit 122 with the good 110 that is now being tracked.

The tracking unit 122 may be encompassed as “smart feet” 144 and coupled under the appliance. FIG. 7 shows the smart feet weight scale 92 reference design in accordance with some embodiments. Smart feet 144 represent an intermediate product, sold to manufacturers and not designed for end-consumers, which may be used to easily retrofit a good 110 or appliance and enable it to be a tracking unit 122 for the service described. There are many products available in the marketplace wherein users are in the habit of filling a container with a consumable good 110 on a routine basis. Smart feet 144 represent an opportunity to work with existing product manufacturers to integrate the tracking unit 122 into their goods 110 or an item including an appliance before sale with minimal effort and few, if any, changes to their existing product designs.

The smart feet 144 or smart foot weight scale 92 reference design may be a universal design and attached to the item or appliance. Examples of the item may include a pet food bowl, a coffee grinder with a bean reservoir, a pill bottle or container, a toilet paper rod or paper towel rod, a propane tank, a spray bottle for liquids such as cleansers, a soap dispenser, or a spice jar. Additionally, a generic bin wherein consumable content may be user-programmable such as flour, or a generic coaster wherein the good 110 may be placed on top, and may be user programmable such as for underneath a hand soap container are also examples.

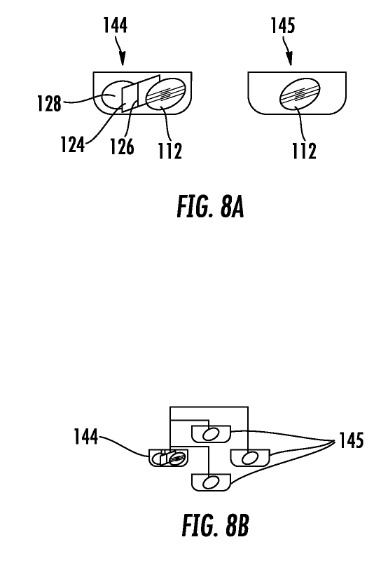

In some embodiments, a good 110 may be measured by one or more smart feet 144, which each may include a transmitter 124 and/or a sensor 112. Smart feet 144 that includes a transmitter 124 and sensor 112 may act independently, sensing and transmitting measured values while smart feet 144 that lack a transmitter 124 or sensor 112 may depend on a complimentary smart foot 144 that includes the needed transmitter 124 or sensor 112 to form a complete tracking unit 122. This enables a single transmitter 124 or transmission hub to be used for each good 110 regardless of the number of smart feet 144 coupled to the item. In use, there may be a primary smart foot 144 or hub that may contain the microcontroller 126, radio or transmitter 124, and power supply 128. Additional smart feet, or secondary smart feet 145, may include only a sensor 112 and may be wired to the primary smart foot 144 to receive power and transmit through the primary's radio. FIGS. 8A and 8B illustrate smart feet 144 in accordance with some embodiments. For example, the primary smart foot 144 and secondary smart foot 145 may be wired together as shown in FIG. 8B. In some embodiments, the primary smart foot 144 may or may not include a sensor 112 depending on the radio or transmitter 124 performance that may be achieved from the configuration of the smart feet 144 coupled to the item. For example, if the transmitter 124 performance does not meet requirements, the sensor 112 may be removed from the primary smart foot 144, and the primary smart foot 144 is then used as a hub that is placed in a more radio-optimal location within, on or near the item.

The primary smart feet 144 and the secondary smart feet 145 may be produced in large quantities, however they may not be wired together or in communication with one another until a specific target good 110 or item is defined. This enables the intermediate product to vary depending on the implementation in number, location, and orientation of the smart feet 144. For example, the implementation may vary in the use of the primary smart foot 144 (as a sensor-enabled smart foot 144 or without a sensor as a hub), the number of secondary smart feet 145, the position of each, and the length of the wiring (if needed between the primary smart feet 144 and secondary smart feet 145). Once the smart feet 144, 145 are provided to the product manufacturer, that manufacturer may be responsible for attaching the smart feet 144, 145 to the target item before sale to the user.

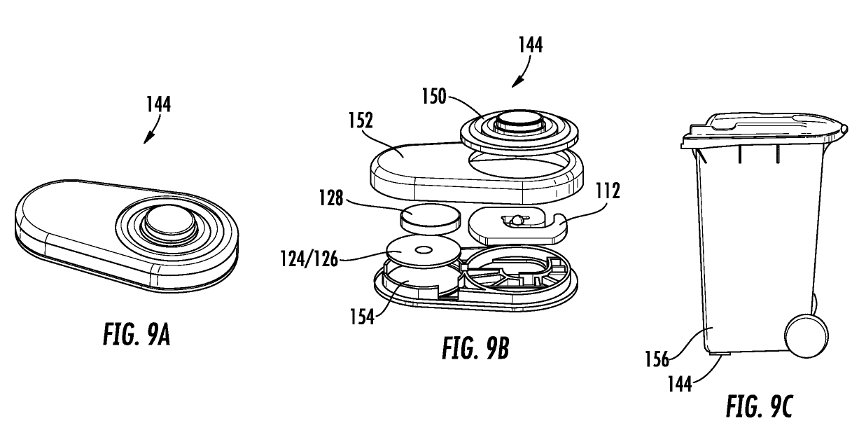

FIG. 9A shows a perspective view of a smart foot 144 in accordance with some embodiments, and FIG. 9B illustrates an exploded view of the smart foot 144 in FIG. 9A in accordance with some embodiments. In some embodiments, the smart foot 144 includes a cover 150, a lid 152, the power supply 128, the radio or transmitter 124, the microcontroller 126, the sensor 112 and a housing 154. The cover 150, lid 152 and housing 154 may be made from a composite, injection molded material, a rubberized material or the like. The sensor 112 may be a flexure with strain gauges as the sensing mechanism. FIG. 9C shows the reference design of the tracking unit 122 as a smart foot 144 in accordance with some embodiments. In this example, the smart foot 144 is coupled to an item such as a bin 156.

In other embodiments, the good 110 or product being monitored through the smart feet 144 on the item may have extra features in addition to triggering an alert to the user regarding the good 110. These may be made available to all tracking units 122 or restricted to a subset of tracking units 122 depending on their implementation, the type of good 110 tracked, the partner relationship (e.g., between owner or operator of the backend or tracking unit design and the manufacturer or reseller), and whether the feature was developed internally (e.g., by the owner or operator of the backend or tracking unit design) or by a partner (e.g., the manufacturer or reseller). As an example of expanded functionality, the backend 120 may transmit an alert to the user device 116 if there is no change in the data 140 of the good 110 in a predetermined timeframe. The predetermined timeframe may be a number of hours, days, weeks or the like based on logged usage. For example, if the weight of the product does not change at an expected rate, the user may receive a reminder alert, e.g., “You forgot to take your pill” or “You forgot to feed the pet”, among others. Similarly, expanded functionality may include tracking of time-based expiration in addition to depletion, such as “Your product has expired” based on time since that good was ordered or added to the tracking system. In other embodiments, the alert may indicate a potential error condition, such as battery depletion or radio failure.

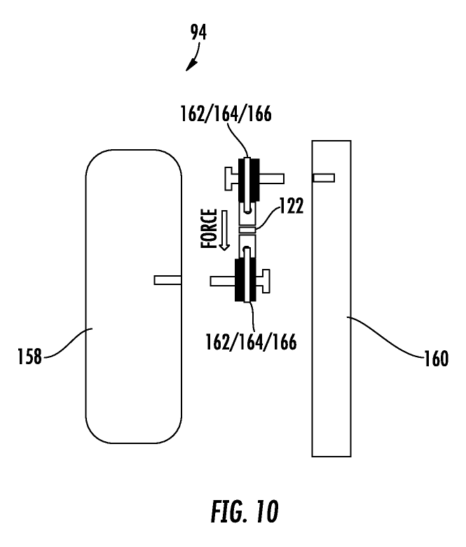

Another embodiment includes a tracking unit 122 for monitoring goods 110 that are contained within hanging dispensers 158, such as hand soap mounted on a wall or a mounted paper towel dispenser. FIG. 10 is the hanging weight scale 94 reference design in accordance with some embodiments. For these situations, the tracking unit 122 is located between the good 110 or dispenser 158 and the mounting surface 160, such that the gravitational force is channeled through the tracking unit 122. For example, the dispenser 158 may be mounted to the mounting surface 160 by fasteners such as a bolt 162 and ring 164. Spacers 166 may be utilized as necessary. This hanging weight scale 94 reference design has mechanisms to stabilize the out of plane torque created by the hanging good 110 or dispensers 158 due to the distance from the mounting surface 160 without allowing the gravitational force to be channeled through a non-sensing surface. These mechanisms include selecting stronger materials for embodiments of the hanging weight scale 94 reference design, limiting the maximum distance of the hanging good 110 or dispenser 158 from the mounting surface 160, and/or adding similar supporting tracking units 122 measuring force perpendicular to gravity.

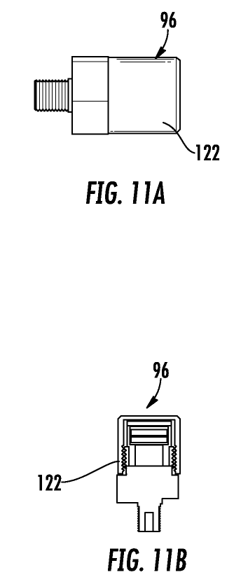

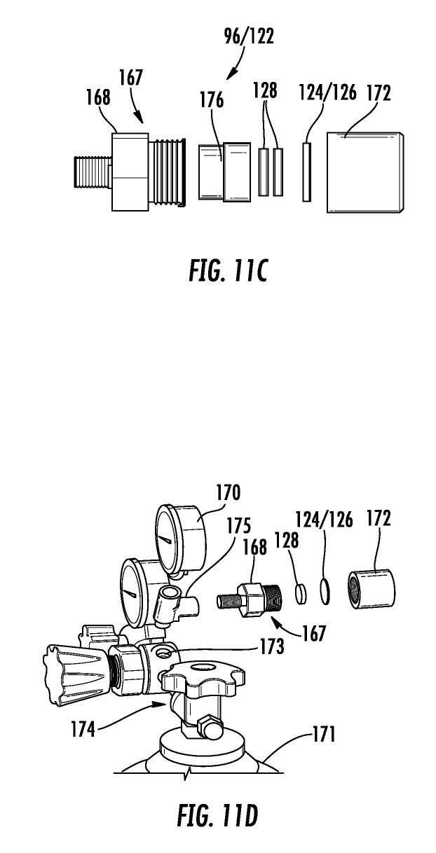

Other systems, including industrial gas, will rely on an embodiment of a tracking unit 122 with a gas pressure sensor 168, as shown in FIGS. 11A-11D. FIG. 11A is the inline pressure sensor assembly 96 reference design for the tracking unit 122 in accordance with some embodiments. FIG. 11B is a cutaway view of the tracking unit 122 as the inline pressure sensor assembly 96 reference design in accordance with some embodiments. FIG. 11C is an exploded view of the tracking unit 122 as the inline pressure sensor assembly 96 reference design in accordance with some embodiments. FIG. 11D is an alternative exploded view of the tracking unit 122 as the inline pressure sensor assembly 96 reference design and a pressure vessel assembly in accordance with some embodiments. In these cases, special care is required to secure the system, support the gauges, and maintain radio performance in an environment with several metal components. To achieve these goals, the gas pressure sensor is situated within a robust metal pressure sensor housing 167 and connected to a high pressure system 174. The sensing mechanism may use diaphragm deflection. A T-Fitting 175 may be added to enable support for a gauge 170 to monitor and read the pressure. Given that the metal pressure sensor housing 167 may disrupt radio communication from the tracking unit 122, in some embodiments, the radio or transmitter 124 and microcontroller 126 are positioned offset from the pressure sensor housing 167. Referring to FIG. 11C, in some embodiments, an optional cartridge 176 in which the power supply 128 is placed is also used as a platform to situate the transmitter 124 and microcontroller 126 away from the metal gas pressure sensor housing 167.

A cap 172 which may be made from a composite material is used to contain the tracking unit 122, while allowing wires to access one side of the gas pressure sensor 168 within the metal pressure sensor housing 167 to take readings. The gas pressure sensor 168 is installed at an upstream port of the pressure regulator 173 to measure the amount of gas remaining in the cylinder 171. The gas pressure sensor 168 may also be located at a downstream port of the pressure regulator 173 to measure the supply pressure.

In further embodiments, a time of flight distance sensor 98 (refer to FIG. 3) reference design may be used. This is an example of a compatible sensor technology using a time-of-flight sensor. These may use laser light to measure volume. Ultrasonic transmitters and receivers are used for range-finding and material mapping which determines volume and density, piezo-resistive elements to identify the location and weight of a good or multiple goods. Simple electrical contacts are placed in close proximity so when a good is removed, a circuit is closed and thus usage count is tracked.

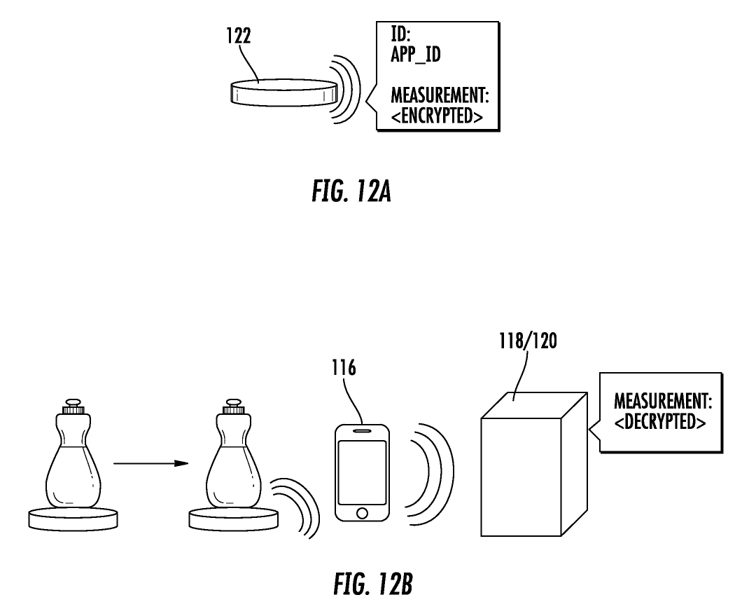

In all reference designs, such as platform weight scale 90, smart foot weight scale 92, hanging weight scale 94, inline pressure sensor assembly 96 and time of flight distance sensor 98, the tracking unit 122 performs the same function. FIGS. 12A and 12B show the method, system or platform in accordance with some embodiments. For example, at a known interval, the current value or measurement of the sensor 112 of the tracking unit 122 is recorded. If the measurement varies from the previous reading, the measurement is frequently read and monitored until it stabilizes for a known amount of time, for example, five seconds. Once stable, the measurement is broadcasted or transmitted by the transmitter 124 of the tracking unit 122 a known amount of times, such as 60 times at intervals of five seconds apart, e.g., as a Bluetooth® Low-Energy (BLE) pulse. In some embodiments, the pulse may be in the standard Eddystone format, but as a custom frame type in which an App ID and the current measurement, encrypted, are transmitted together.

Abiding the Eddystone standard, any nearby device 116, such as a smartphone with the corresponding App installed, may receive the BLE pulse, regardless of whether the owner of the smartphone also owns the broadcasting unit. This enables devices 116 with the App to be used as a relay for tracking units 122 that the relay-owner does not own, but without providing any visibility or access to the data being sent to the relay-owner as it is encrypted by the tracking unit 122. The measurement is transmitted via the communication technologies 114 and received to the backend 120. No matter the relay used, the server 118 or computer in the backend 120 is able to decrypt the measurement and log it alongside other measurements submitted by the transmitting tracking unit 122, providing all functionality as normal.

In some embodiments, Bluetooth® Low Energy broadcasts may submit the weight measurements for the data 140 to a backend 120 through the relay device 116. In typical Bluetooth® Low Energy implementations, the pulse interval is static and the tracking units 122 only broadcast a static ID as the pulse payload. In the firmware implementation of the method, system or platform, both the pulse interval and the pulse payload are dynamic from the tracking unit 122. Instead of occurring at a static rate of some pre-defined number of X seconds for the lifetime of the unit, tracking units 122 may have multiple transmission modes with varying frequency. For example, if the tracking unit 122 has not detected a change in the data 140 of the good 110 for an extended period, such as five minutes, it will “downshift” to a lower transmission rate, e.g. one pulse every 60 seconds. The same tracking unit 122 may “upshift” to a more frequent transmission rate after a measurement change is detected, e.g. one pulse every five seconds. The rate differs between form factors. Some, e.g., for home and retail use cases, will pulse quickly, for example, every 1 to 5 minutes and others, e.g., industrial use cases, may pulse very infrequently, for example, every 15 minutes to 1 hour. In other embodiments, the pulse rate ranges from every 1 to 15 minutes. This method greatly reduces battery consumption over the life of the device 116. As well, rather than sending a static ID as the payload, as is the case for current “beacon” implementations using the Eddystone standard with existing frame types, the tracking unit 122 sends its ID alongside the current measurement from the sensor 112 as a variable, encrypted payload. Receiving devices 116, like smartphones with the corresponding App installed, may then receive and upload the encrypted measurement and tracking unit ID value to the backend 120, where it may be decrypted and associated to the other measurements from that tracking unit 122.

While the reference designs 90, 92, 94, 96 and 98 enable manufacturers or resellers to assemble many implementations of the tracking unit 122, there is also the opportunity to integrate the radio or transmitter 124, microcontroller 126, and sensor 112 into a single module for price and simplicity. In some embodiments, the sensor 112 may be replaced by coupling, such as by printing, interleaved wires onto the tracking unit 122 board assembly directly. This may replace a strain gauge or sensor 112 by measuring the deflection of the assembly itself. Likewise, the radio or transmitter 124 may take on the responsibilities of the microcontroller 126, simply reading measurements from the sensor 112 and transmitting the measurements as pulses, further reducing the components required to the board assembly, transmitter 124 and power supply 128. These integrated modules may then be manufactured in great volume and used in the same way as embodiments of the reference designs 90, 92, 94, 96 and 98 at reduced complexity and cost.

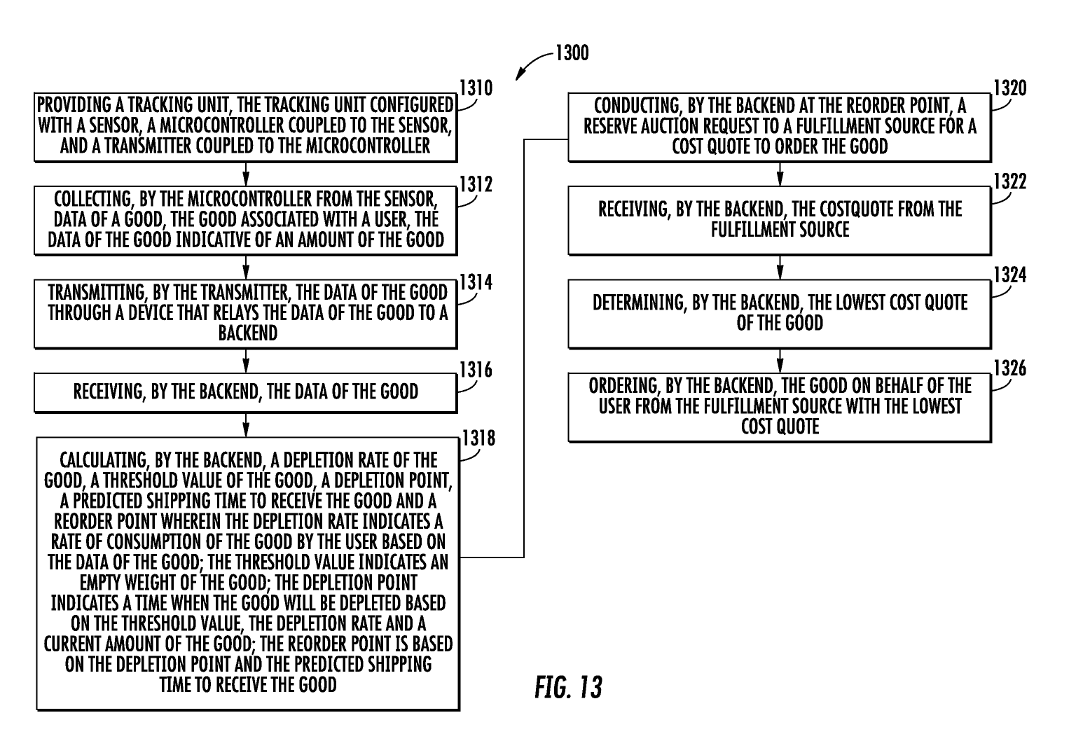

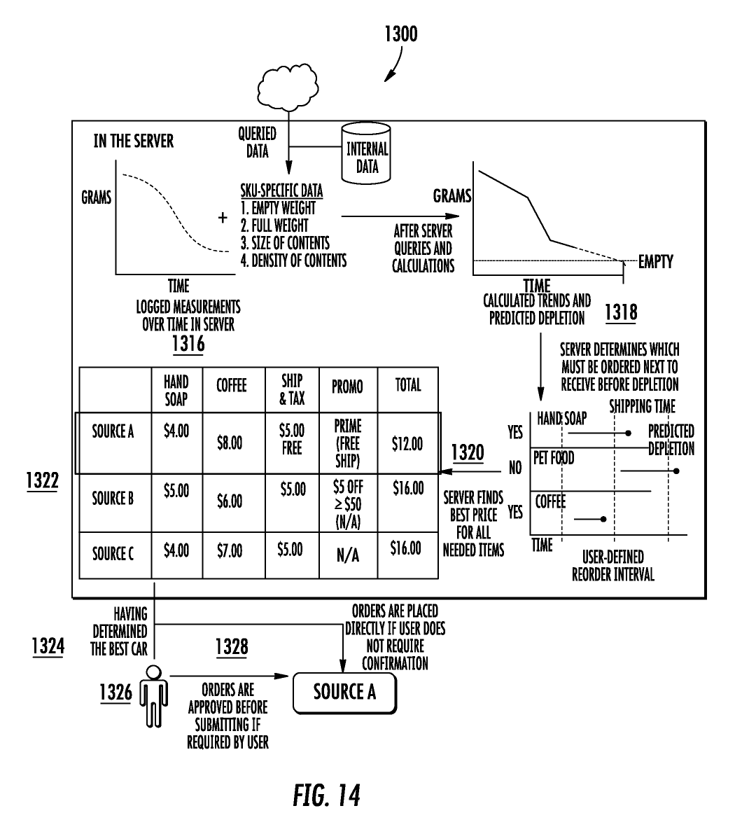

FIGS. 13 and 14 are simplified flowcharts of the method, system or platform for the prediction of consumption and reordering of goods 1300 in accordance with some embodiments. For example, at step 1310 the method includes providing the tracking unit 122. At step 1312, data 140 of a good 110 associated with a user is collected, e.g., by the microcontroller 126 from the sensor 112. The data 140 is indicative of an amount of the good 110. At step 1314, the data 140 is transmitted by the transmitter 124 through a device (e.g., 116) that relays the data 140 to a backend 120. The backend 120 receives the data 140 at step 1316 and, at step 1318, calculates a depletion rate of the good 110, a threshold value of the good 110, a depletion point, a predicted shipping time to receive the good 110 and a reorder point. The depletion rate indicates a rate of consumption of the good 110 by the user based on the data 140 of the good. The threshold value indicates an empty weight of the good 110. The depletion point indicates a time when the good 110 will be depleted based on the threshold value and the depletion rate and a current value of the data 140 of the good 110. The reorder point is based on the depletion point and the predicted shipping time to receive the good 110.

At step 1320, at the reorder point, the backend 120 conducts a reverse auction, requesting from each fulfillment source a cost quote to order the good 110 and any other goods 100 that will need to be ordered in this timeframe. At step 1322, the backend 120 receives the cost quotes from the fulfillment sources. At step 1324, the backend 120 determines the lowest total cost quote for replacing all goods 110. Optionally, the backend 120 transmits a notification to a user device 116 associated with the user. At step 1326, the backend orders the good 110 on behalf of the user from the fulfillment source with the lowest cost quote, with or without the user confirming the order depending on the user's settings.

The user may obtain the tracking unit 122 from any manufacturer or reseller of the tracking unit 122 or the good 110 in which the tracking unit 122 is integrated, wherever the tracking unit 122 is available. In some embodiments, the tracking unit 122 is pre-programmed with or in the good 110 such as integrated into the packaging. In another embodiment, the user may choose the good 110 to be monitored and thus may set the good 110 by for example, scanning the barcode, taking a picture of the good 110 to programmatically identify the good 110 or using a Mechanical Turk system.

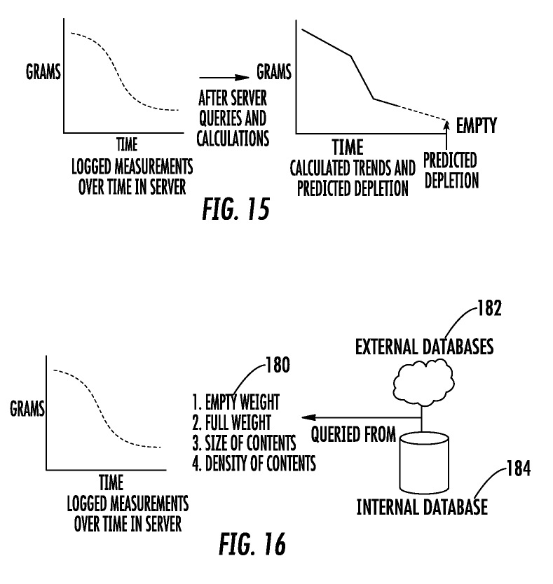

FIGS. 15 and 16 illustrate the calculation and the prediction of depletion in accordance with some embodiments. As the consumable good 110 is used, the tracking unit 122 detects the change in the amount, such as by measuring the weight, and the measurements over time are logged in the server 118. These measurements are transmitted as a BLE pulse in some embodiments. This pulse is received by the device 116 which may be BLE and/or Internet enabled, such as a smartphone with the App, then uploaded to the server 118 in the backend 120.

On a set interval, the future time of depletion is calculated by the backend 120 for the consumable good 110. This calculation relies on the measurements or data 140 submitted for that consumable good 110 by a tracking unit 122 and SKU-specific data 180 about the consumable itself, which may be gathered from external databases 182 and/or measured by a team member and stored to an internal database 184. The external databases 182 are located remote from the method, system or platform may be provided and maintained by the manufacturer. The internal database 184 is part of the method, system or platform. The SKU-specific data 180 generally includes the empty weight, the full weight, the size of the contents and the density of the contents, or any appropriate combination thereof.

The backend 120 receives the data 140 and calculates a depletion rate of the good 110, a threshold value of the good 110, a depletion point, a predicted shipping time to receive the good 110 and a reorder point. The depletion rate indicates a rate of consumption of the good 110 by the user based on the data 140 of the good. The threshold value indicates an empty weight of the good 110. The depletion point indicates a time when the good 110 will be depleted based on the threshold value and the depletion rate and a current value of the data 140 (e.g., current weight) of the good 110. The reorder point is based on the depletion point and the predicted shipping time to receive the good 110. For example, data on the empty weight, such as the weight of the container without the consumable contents, is typically known and can be used for the calculations. If the consumption trend of the good 110 is known, for example, grams of good used per unit time as measured by the tracking unit 122, the depletion rate may be calculated in one of two ways. In the first way, for example, the “empty weight” of a consumable good 110 may be known by the backend 120, so the time to depletion may be calculated using:

(current weight−empty weight)/consumption trend=time to depletion

Generally, the empty weight information is not available from existing databases, but may be collected in three different ways. First, manually, such as weighing the empty good 110. This may be by an employee of any entity participating in this method, system or platform. Once measured, the information is added to the internal database 184 or through a defined mechanism of users such as submitting this data measured through the smartphone App. Second, estimated statistically using the weight at which the good 110 is often replaced by all users of the system. Third, calculated as a byproduct of the second calculation method described below. Meanwhile, current weight is known through the current measurement of the tracking unit 122.

In the first way, for example, the “size”, such as the amount of the consumable material contained within the good 110, and the “density”, such as the conversion of the default size unit into grams of the good 110, may be determined. The time to depletion may be calculated using:

(size×density)/consumption trend=time to depletion

Generally, size information is available from existing product external databases 182, and density may be estimated across a category of goods, and existing product external databases 182 provide a known category for a given good 110. Clustering of like products may be used to share density values across goods in a category, for example, liquid soaps have a density of roughly 1.1 g/mL. Employees of an entity participating in the method, system or platform may provide any needed data, such as measuring the density and empty weight of consumable goods 110, while the average density of goods in a category may be used if the information of a specific good 110 is not available.

If the empty weight of the good 110 is not known, the full weight of a good 110 may be used with this function to calculate the empty weight. The largest initial measurement from the tracking unit 122 for a particular good 110 may be considered the full weight. In this scenario, the empty weight may be calculated using:

full weight−(size×density)=empty weight

Based on the measured values, trends may be calculated via statistic techniques such as linear regression to maximize accuracy while minimizing the number of trends identified. The most recent trend may then be projected forward until it intersects the known empty weight of the consumable good 110 to determine an expected or predicted time of depletion or the depletion point.

FIGS. 15 and 16 show the graphs projected forward based on the calculated depletion rate. An extrapolation of the graphs (based on the calculated depletion rate) intersect a threshold value for the consumable good 110 at some time in the future establishing the predicted depletion time or depletion point. In some embodiments, the threshold value indicates an empty weight of the good 110. Depending on the consumable good 110, available fulfillment sources for that consumable, and the shipping destination, the predicted shipping time is estimated and a notification to the user will be scheduled before the predicted depletion point to allow for the predicted shipping time. In some embodiments, the reorder point is further based on a buffer. The buffer may be a buffer time (e.g., a number of days optionally based at least in part on the predicted shipping time) and/or a buffer weight (e.g., indicating a minimum amount of the good 110 above the empty weight). In some embodiments, the buffer may be added to the predicted shipping time, or the predicted shipping time is overestimated. For example, the buffer time may be a set number of days, may depend on the predicted shipping time or may be zero. In other embodiments, the buffer weight may be a weight indicating a minimum amount of the good 110 above the empty weight. This ensures that the shipment will be delivered before depletion can occur. For example, the minimum amount of the good 110 provides a buffer weight so that the good 110 doesn't run out before the reordered good 110 is received. Maintaining a calculated depletion rate within the server 118 ensures the system will continue to function and place orders even if tracking units 122 are unable to communicate with the server 118 for a period of time. In other words, given a last known amount of the good 110 (i.e., the most recent value of the data 140) and the calculated depletion rate (based on at least two values of the data 140), the reorder point can be calculated or estimated, even before the data 140 indicates that the amount of the good 110 has reached the threshold value.

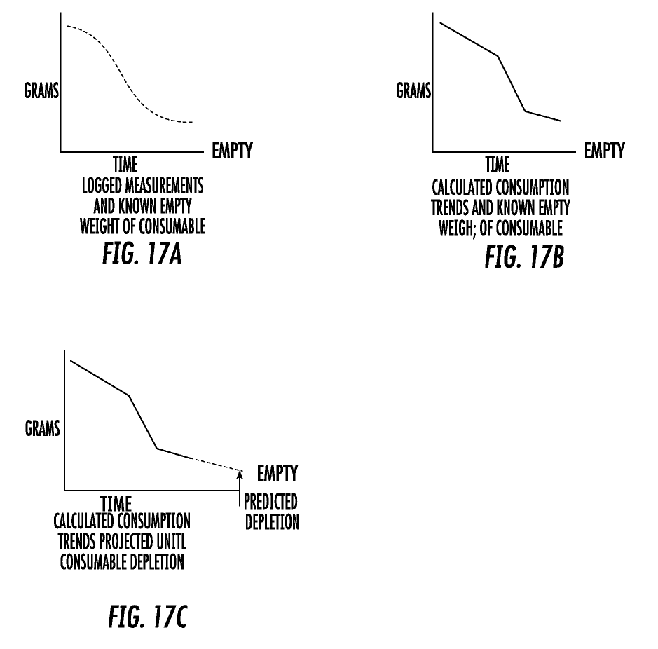

FIGS. 17A-17C illustrate simplified graphs of the method in accordance with some embodiments. FIG. 17A depicts a simplified graph of logged measurements and a known empty weight of the consumable good 110. FIG. 17B is a simplified graph of calculated consumption trends and known empty weight of the consumable good 110. FIG. 17C shows a simplified graph of calculated consumption trends projected until consumable depletion or the depletion point.

In some embodiments, the tracking unit 122 may measure a different value and/or employ a different calculation method to determine the current amount of the good 110 remaining, depletion rate, threshold value, depletion point and reorder point. Different units of measure may include volume, such as measured by a gas pressure sensor or measuring the height of a liquid d in a container of known dimensions using a floating bobber. Other examples may include the total interference of transmitted light through the liquid or may include count of the good 110. For example, a weight tracking unit 122 may be integrated in a bug/vermin trap or a diaper trash bin measuring a unit of consumption as an increase in weight rather than a decrease, e.g., “plus one diaper used” when the diaper trash bin registers an increase in weight.

In some embodiments, instead of calculating the time of the reorder point, the tracking unit 122 and/or the backend 120 monitors the amount of the good 110. When the amount of the good 110, as indicated by the data 140, reaches a threshold value, the backend 120 starts the reorder process, e.g., the reverse auction or reordering the good 110, as described herein. In this case, the threshold value is based on the empty weight of the good 110 plus a minimum weight. The amount of the minimum weight (MW) is generally based, at least in part, on the predicted shipping time (PST) and the depletion rate (DR), e.g., MW=PST×DR. Additionally, to ensure that the new order of the good 110 arrives before the user runs out of the previous order of the good 110, the threshold value may be inflated or overestimated by 1) overestimating the minimum weight or the predicted shipping time, 2) adding a buffer weight to the minimum weight, and/or 3) adding a buffer time to the predicted shipping time.

The good 110 or product being monitored may have extra features, such as triggering an alert to the user regarding the good 110 other than about the upcoming depletion. The backend 120 may transmit the alert to the user device 116 if there is no change in the data 140 of the good 110 in a predetermined timeframe, if the weight reaches a critical value or for a system malfunction such as a low battery or transmitter 124 failure. The predetermined timeframe may be a number of hours, days, weeks or the like based on logged usage. For example, the user may receive an alert of “Empty the bug/vermin trap; it's full”. In another example, data is logged and communicated to the consumer. This may be by a graph, such as showing the baby's excrement over time via a diaper trash bin. In a further example, the user may receive the alert of “change battery”.

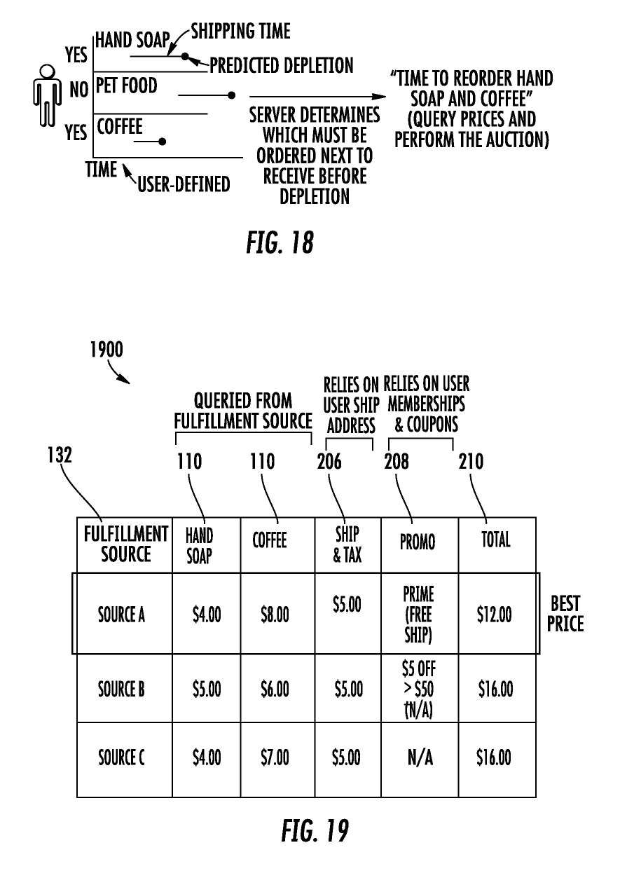

The user may set preferences in the method, system or platform to be notified on a recurring basis of all goods 110 expected to deplete in the next certain number of days. The preferences of the user may include when to reorder goods 110 based on a set number of days before the good 110 is completely depleted. The method, system or platform uses this information along with the knowledge of the required shipping time for each good 110 by the server 118, and the server 118 may periodically notify the user about items or goods 110 for which depletion is imminent and/or items for which orders may be placed now to ensure depletion does not occur before shipping can be completed. FIG. 18 demonstrates the method in accordance with some embodiments. In some embodiments, based on the preferences of the user, the goods 110 may be automatically reordered. In another embodiment, the user may need to give confirmation before reordering. For example, a summary and one-click cart may be prepared for the user where the cart represents each good 110 to be reordered and the lowest cost source for all needed goods 110 including shipping, taxes and promotions, but requiring a user action to submit the orders.

When the reorder point is reached, the backend 120 conducts a reverse auction request to a fulfillment source for a cost quote to order the good 110. The backend 120 receives cost quotes from all fulfillment sources for all goods 110 that will require replacements within the user-specified timeframe and determines a lowest cost quote for the total order from one or more fulfillment sources. The method, system or platform may have an existing relationship with the fulfillment source, including a defined referral fee, for that fulfillment source to be included in the reverse auction. In some embodiments, only some users may have access to certain fulfillment source, e.g. if a membership in a “buying club” or other network is required to purchase the good 110 from a specific source or at a “members-only” price. Examples range from Costco membership, required to purchase any goods 110 from Costco, to Amazon Prime which provides free shipping to members when they order from Amazon.com. Similarly, there may be promotional offers, for all users or for only redeeming users such as with a coupon code, and the reverse auction system may be aware of these memberships and promotions to include these benefits in when calculating the lowest price for a set of goods 110 for a specific user.

Using this information and other data, such as the location of the user to predict shipping costs, the lowest cost source for each good 110 may be selected as the recommended fulfillment source. In some instances, purchasing all of the goods from the same source may cost less than separating the orders. For example, shipping costs may be saved if all goods 110 come from the same source or enabling redemption of a promotion like “$5 off of orders $50 or more”. In some cases, these may be automatically selected, when there is no tradeoff to be considered, while in others scenarios they may be presented to the user for the user to select the source.

FIG. 19 illustrates a simplified table 1900 of the results of the reverse auction in accordance with some embodiments. This provides an example scenario to demonstrate this embodiment, but not limit the scope of the present invention. For example, the sample table 1900 is the notification to the user for each good 110 depleting or running out soon, and in this example, hand soap and coffee. The method, system or platform conducts the reverse auction and the three lowest cost quotes 210 from fulfillment sources, Source A, Source B and Source C, are presented to the user. The actual shipping and tax 206 based on the address of the user is listed. Additionally, promotional offers 208, such as memberships and coupons are shown. In this case, Source A has the best price for the reorder.

In other instances, the reverse auction may achieve the best per-user price by aggregating orders for the same goods 110 for different users from the same source, or purchasing different goods 110 for the same user from the same source, or purchasing different goods 110 for different users from the same source. For example, the known depletion rates for the same good 110 tracked by multiple users may indicate the opportunity to aggregate multiple users' reorders into one bulk purchase. In these cases, the system may submit the bulk order with shipping to the system's warehouse, where the bulk order is broken into smaller quantities by operators of this system before sending the order to the end user. Similarly, multiple different consumer goods 110 may be tracked by a single user and the best total price for all items or goods 110 that need to be replaced may be from one single or multiple separate sources. Each source may provide separate bids for each good, and the source with the best combined price for all of the goods 110 may be selected or a combination of sources may be selected, depending on the price of each good 110 from each source added to the incidental costs for each source, like shipping and tax 206.

The backend 120 transmits a notification to a user device 116 associated with the user and orders the good 110 on behalf of the user from the fulfillment source with the lowest cost quote 210. For example, the user may elect to receive notifications and confirm each order before it is placed, or may set the method, system or platform to automatically order the good 110. In the case of automatically ordering the good 110, the user may have a set timespan to review and edit the order. If no action is taken, the order is placed.

In some embodiments, before the user is notified for the reordering process, data for the user and the goods 110 being monitored is used to target advertisements for other products, such as an alternative brand or an additional product, which are included in the notification. The notification may be sent to the device 116 of the user by a smartphone App and/or email. In addition to performing the auction to generate recommended fulfillment sources, the backend 120 may generate advertisements and incorporate these into the notification to the user. These advertisements may be targeted to the particular user based on currently monitored goods 110 of the user, rates of consumption of the good 110 by the user, order history of the user and any other available demographic information about the user. The advertisements may represent potential additional goods 110, additional tracking-enabled goods or appliances, alternative brands for already tracked good types, or the like.

The notification may suggest alternative brands of the good 110 to order with incentives for the consumable good manufacturer, fulfillment source or advertiser. The incentives for these may be a reduced referral fee or a cease of alternative brand suggestions. For example, the consumable good manufacturer, fulfillment source or advertiser may be able to pay to cease alternative brand suggestions for users that already track and reorder their product or for the selected good type for a defined period of time.

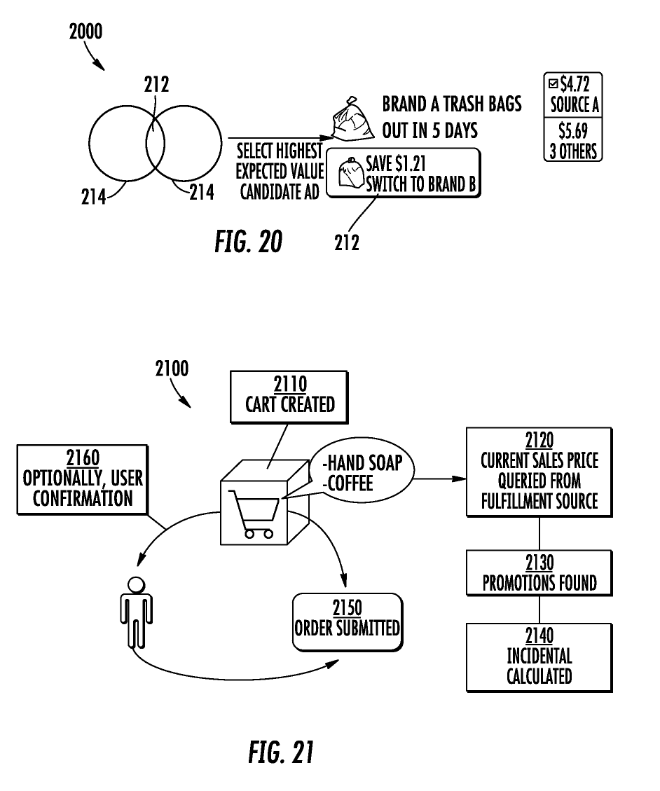

These advertisements may describe new products, “You're running low on shampoo, would you like to add Brand A conditioner to your next order?” or replacements for products the user already tracks, “Switch to Brand B trash bags to save $1.21”. These may be subject to potential restrictions. The user may select any advertisement shown to change or add products to his/her shopping cart, and when confirmed, orders are placed for all goods 110 with an auction-selected source. FIG. 20 is a simplified schematic 2000 of the method, system or platform in accordance with some embodiments. Here, candidate ads 212 are shown from people buying goods 214. The highest expect value candidate ads 212 is displayed to the user. Therefore, when the user has Brand A trash bags and the projected depletion is 5 days, the candidate ad 212 may be “Switch to Brand B trash bags to save $1.21”. If the user prefers to reorder the Brand A trash bags, the lowest cost quotes 210 from the results from the reverse auction are displayed for selection.

In the case of the alternative brand advertisements, in some embodiments, the user may click the advertised, alternative brand and select the advertised good 110 for his/her next order and all future orders, until another change is made by the user. For example, if the user selects to replace the trash bags with Brand B trash bags, those may be the pre-selected version for future orders. In this example, the advertiser may be asked to define a payment schedule including the first order and future orders that result from a click on their advertisement. For example, the advertiser might agree to charge $1 for the first order resulting from a click on their advertisement, and charge $0.50 for orders two through five. As a result, the system would not show alternative advertisements, e.g. the cost for a different brand of trash bag, for five orders and receive revenue for each; however, an advertisement for another brand may be shown after the payment schedule is completed, potentially starting a new payment schedule if that advertisement is clicked.

FIG. 21 is a simplified flowchart of the confirmation inquiry 2100 of the method, system or platform in accordance with some embodiments. Before sending notifications to the user about depleting goods 110, in flowchart 2100, in step 2110, a cart is created with each good 110 that needs to be reordered at the lowest total price available. To achieve the best, lowest price, the total price for each source and combination of sources is calculated. In step 2120, the current sales price is queried from each available fulfillment source, such as Amazon.com, Walmart, or the like. In step 2130, promotions may be found for each source including special memberships that may or may not apply, such as free shipping for members based on the particular user, and other coupons and incentives that may or may not have prerequisites, such as “save 10% on orders $50 or more” or “$2 off Brand A”.

In step 2140, incidentals like shipping, tax, and other potential fees are queried from each fulfillment source using the known shipping address for the user. Notably, in some cases, the lowest total price may be from a single source and in other cases, multiple sources may be needed. Knowing the optimal orders to submit, the orders may be automatically submitted at step 2150 to the fulfillment source selected or optionally, at step 2160 sent to the user for confirmation before submitting the order, depending on the preference of the user.

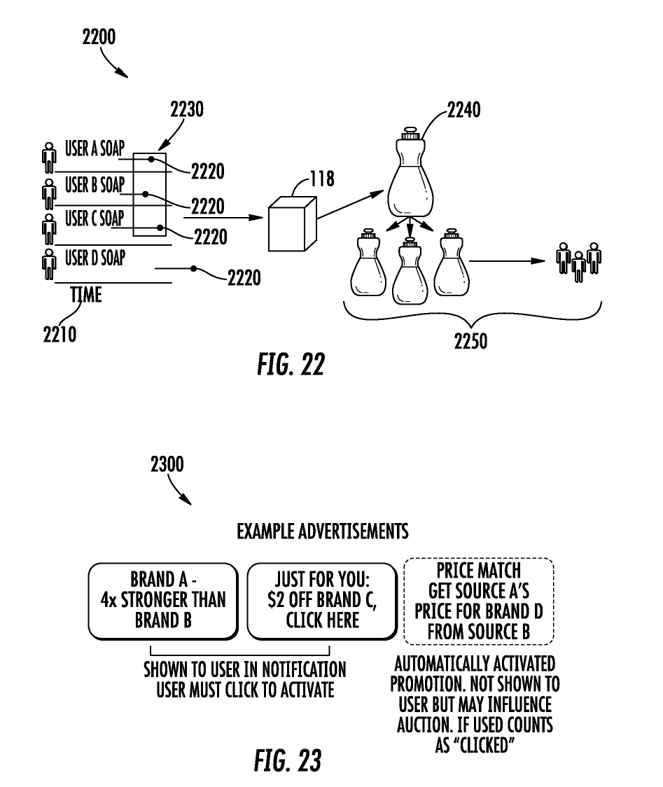

In addition to knowing which goods 110 are in use by multiple users and when each will deplete, there may be the opportunity to aggregate orders. FIG. 22 depicts a simplified flowchart for aggregating orders 2200 of the method, system or platform in accordance with some embodiments. For example, a graph of multiple users consuming soap over time 2210 is shown. The predicted depletion for a consumable good 110 monitored by a single user and the depletion point for other users monitoring that good 110 is known. If multiple users have similar depletion points 2220 for the same good 110, the amount of goods 110 to be reordered may be combined and product databases may be queried for the same good 110 in multiples encompassing the orders of the multiple users having similar depletion points 2220 for the same good 110 instead of only an individual user order. Arrow 2230 indicates the potential to aggregate user A, B and C's soap orders based on the predicted depletion. The server 118 places one soap order for user A, B and C.

Moreover, if the combined larger size order supports the combined orders at a more efficient price, the method, system or platform may purchase the combined larger size order in advance and deliver the good 110 to the method, system or platform inventory for storage. This is represented as 2240. As depletion nears for each user, orders may be directed to the method, system or platform inventory for fulfillment until depleted. This is represented as 2250. In this way, the fulfillment source is the same as the backend 120.

Advertisements may be shown to the user in the depletion notification. The advertisements may be targeted to the particular user based on the system's knowledge of the user from the preferences of the user, the data of the monitored consumable goods 110, and the depletion rate of each consumable good 110. These advertisements may take the form of simple display advertisements, special deals or coupons that may be activated by the user or promotions that may be automatically considered and activated by the auction without being shown as a visible advertisements unit to the user. The system may still monetize these as if they had been selected as their goal would be accomplished, for example, an advertisement with a product discount if a certain amount is purchased. FIG. 23 are example advertisements 2300 in accordance with some embodiments.

While the advertisements may appear the same, different classes of advertisers may be supported with different goals and implementations. In some embodiments, consumable goods manufacturers may advertise their products and the advertisement offered may be for a “subscription” to a consumable good 110. This means that, when a user clicks the advertisement, the selected product or good 110 may be added or replaces another good 110 in the current order. In addition, in some embodiments, this good 110 may be selected for future orders as well.

As such, advertisers agree to a payment plan to the method, system or platform depending on the total number of orders for that consumable, for instance, $1 for the first order and $0.50 for orders two through five. A “blackout” period may be agreed so that another advertisement for a competing consumable good 110 is not shown for a certain amount of orders, such as for five orders.

In another type of advertisement, fulfillment sources may attempt to redirect orders to that source, regardless of the good 110 being ordered. Fulfillment sources have less traditional goals for their advertisements than manufacturers of consumable goods 110, attempting to redirect orders to their fulfillment service regardless of the consumable good 110 being ordered. Fulfillment source advertisements may be considered after the auction is completed, when the optimal cart and sources are defined. Advertisements for fulfillment sources that were not selected by the reverse auction or for which only some of the order was selected, may be considered.

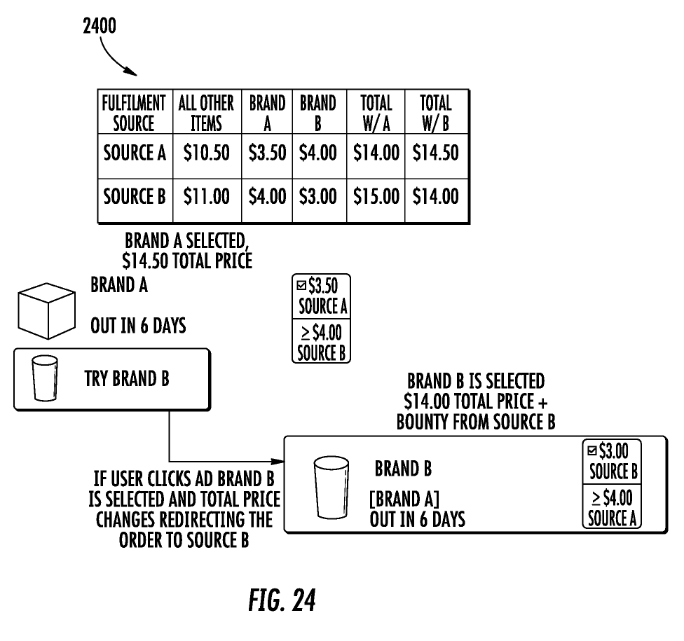

In setting up these advertisements, fulfillment sources may not define a specific consumable good 110 or good type which they wished the user to select, but rather define rules associated with a bounty when that action is accomplished. For example, the fulfillment source, such as Source A, may pay to the system operator $5 for every redirected order for $50 or more. To achieve these bounties, the system may show an advertisement for a consumable good 110 to the user that it knows. If that consumable good 110 is selected by the end user, the total price will be adjusted and the order redirected to the bounty payer. This means that an advertisement for a certain brand of good 110 may be shown not because that brand owner has paid for an advertisement, but because the system knows that if the user selects that brand, changing his/her previously selected brand or adding a new good 110 to the order. The total price for the order may be less at the bounty-paying fulfillment source. In some cases, the advertisement may have promotion parameters that may impact the total price and may be automatically “clicked” or selected for the user. For example, Source B may price match Source A for Brand A and pay a bounty for each redirected order. FIG. 24 is a simplified schematic of an advertisement 2400 by the fulfillment source in accordance with some embodiments.

To collaborate with existing consumable good manufacturers and potential fulfillment sources, the method, system or platform may be configurable to enable the manufacturer or reseller or fulfillment source to lock the specific good 110 that is reordered by that unit and/or lock the fulfillment source from whom replacements for that unit are ordered. In particular, this supports embodiments where a consumable good manufacturer, reseller or fulfillment source may sell a tracking-enabled product.

The manufacturer of the good 110 being monitored may be affiliated with a fulfillment source, for example, Manufacturer A makes Source A drawer organizers or Manufacturer B makes Source B coffee grinders. In these cases, the auction-based system for reordering may not be feasible as the appliance or good manufacturer has an interest in maintaining control of the reorders. To support these cases, the manufacturer may be given a simple configuration tool to modify the behavior for this model of the tracking unit 122 by configuring the tracking unit firmware or saving the configuration of the tracking unit 122 in the cloud. The manufacturer may select “locked consumable” meaning the tracking unit 122 is set to reorder a specific consumable good 110 and cannot be changed. The tracking unit 122 may be prepackaged in the good 110 such as at the bottom of the laundry detergent. The setting may not change the auction-based replacement model, which proceeds as normal. Similarly, the manufacturer may select “locked fulfillment” meaning the tracking unit 122 may support a variety of consumable goods 110 as options to reorder, but it may only order replacements from the locked fulfillment source. For example, a Source B coffee grinder may only order Brand B beans where Source B is the same as Brand B, though the user may choose the beans amongst Brand B's available options. “Locked fulfillment” interrupts the referral-revenue system, so a service-revenue model may be pursued. In some embodiments, the manufacturer may agree to a monthly fee per unit that leverages the system.

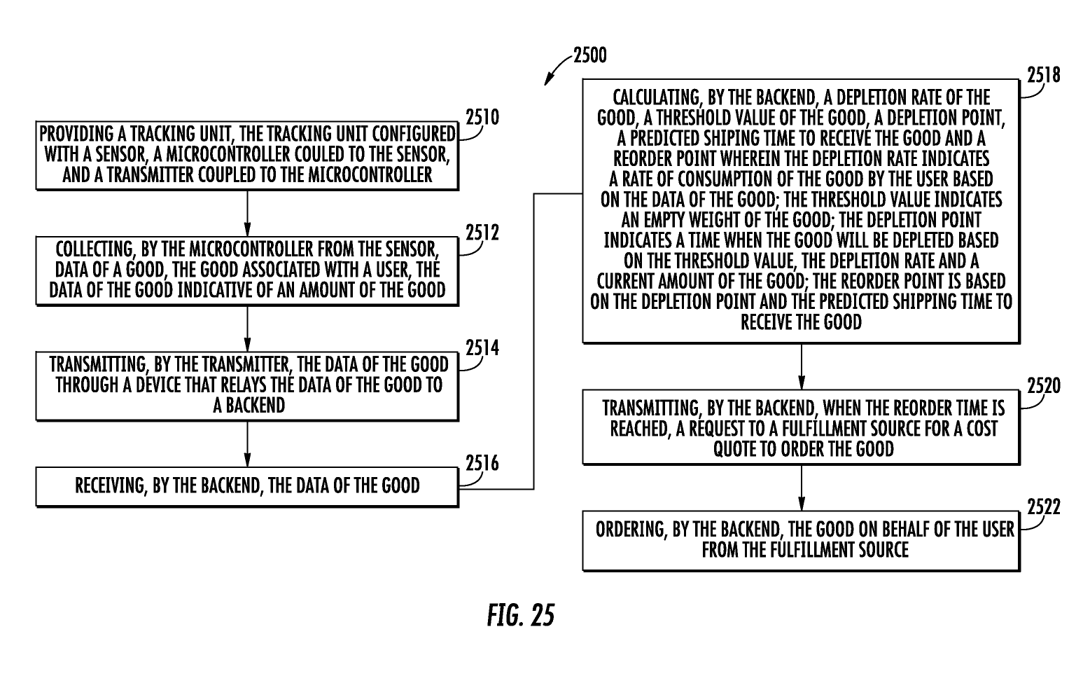

FIG. 25 is a simplified flowchart for a method 2500 for the prediction of consumption and reordering of goods in accordance with some embodiments. The method 2500 includes, at step 2510, providing a tracking unit 122. The tracking unit 122 is configured with a sensor 112, a microcontroller 126 coupled to the sensor 112, and a transmitter 124 coupled to the microcontroller 126. At step 2512, data 140 of a good 110 is collected by the microcontroller 126 from the sensor 112. The good 110 is associated with a user and the data 140 is indicative of an amount of the good 110. At step 2514, the transmitter 124 transmits the data 140 through a device 116 that relays the data 140 to a backend 120. At step 2516, the backend 120 receives the data 140 and at step 2518, calculates a depletion rate of the good 110, a threshold value of the good 110, a depletion point, a predicted shipping time to receive the good 110, and a reorder point. The depletion rate indicates a rate of consumption of the good 110 by the user based on the data 140 of the good. The threshold value indicates an empty weight of the good 110. The depletion point indicates a time when the good 110 will be depleted based on the threshold value and the depletion rate and a current amount of the good 110. At step 2520, at the reorder point, the backend 120 transmits a request to a fulfillment source for a cost quote to order the good 110. Optionally, the backend 120 transmits a notification to a user device 116 associated with the user. At step 2522, the backend 120 orders the good 110 on behalf of the user from the fulfillment source. The fulfillment source pays a premium, for example, a fee.

In one scenario, the consumable good provider may want to integrate the tracking unit 122 into a certain brand of laundry detergent before sale. The fulfillment source or manufacturer may have an interest in ensuring that their brand is reordered and does not want advertisements for other brands of laundry detergent shown to users. To prevent this, the tracking unit SKU may be configured by the manufacturer to pre-program and lock the consumable good 110 associated with that tracking unit 122. For example, this enables the laundry detergent provider to create a new tracking unit SKU for their brand of laundry detergent, configure that SKU to be locked to the brand of laundry detergent in the backend 120, and integrate tracking units of that SKU type into each bottle of laundry detergent. When such a bottle is purchased by a user, the user may associate the good 110 with his/her account such as through a smartphone app, and the brand of laundry detergent appears without programming. Likewise, when the laundry detergent depletes, the backend 120 suggests the lowest cost source for that brand of laundry detergent without showing alternative laundry detergent brands as it would otherwise.

In another scenario, the fulfillment source may be locked for a certain tracking unit SKU. This may support ‘big box’ stores and other retailers that may sell self-branded tracking unit SKUs, but want those SKUs to only order from that retailer in the future. For example, a retailer may design the tracking unit SKUs like smart drawer organizers or coffee grinders that are locked to the specific retailer respectively. These implementations may be programmed by the user with the specific good 110 or flavor of coffee to be tracked but at the time of depletion, rather than conducting an auction to select the lowest cost fulfillment source, the method, system or platform may select the locked fulfillment source. This bypassing the reverse auction mechanism for the good 110. In some embodiments, the fulfillment source may provide an additional discount to the user if the method, system or platform is employed to support the interests of the user.

In further embodiments, the tracking units 122 may automatically identify goods 110 placed upon them. This may be with a shelf with a scanner and/or camera. The shelf may be configured to scan the surface and identify what the added or removed good 110 is visually rather than requiring the user to program. The shelf may be configured with RFID technology therefore scanning the surface with RFID technology instead of visually.

The method, system or platform may be used for enterprise applications thereby providing solutions for businesses. For example, in a bar setting, the tracking units 122 may be placed along the bar under each bottle of alcohol thereby monitoring inventory where that inventory is already maintained and without requiring any changes to the businesses current operation. This system also enables eliminating inventory checks by a paid employee for inventories that may be non-centralized, like liquid soap or paper towel in the company bathrooms, by including tracking units 122 at the site of use rather than in warehouses or stockpiles, as existing systems provide. As another example, tracking units 122 may be placed on shelves within all of a company's trucks to maintain inventory, such as on cable company trucks to ensure there is always inventory, such as cable boxes, on board. Finally, in a storage, manufacturing, lab or medical, or retail facility setting, the tracking units 122 may be placed at various points in a logistic process to detect items or goods 110 moving through the process and reveal bottlenecks without requiring modifications to the assembly line or existing processes.

In one scenario, the source may be a distributor or other vendor that provides ongoing deliveries of goods 110 to the source's customers, e.g. an industrial gas supplier delivering tanks of pressurized gas or a sanitary supply distributor refilling a customer's hand soap and paper products. In these cases, the source, i.e. the distributor, provides tracking units 122 to their customers or integrates tracking units 122 into their products before delivery. For example, the distributor may provide hand soap dispensers which include a tracking unit 122, or the distributor may attach the tracking unit 122 to each bag of hand soap used within the dispenser before delivery. The sensor data from these tracking units 122 is collected as usual, but the data and leanings generated are available to the distributor and only to the distributor's customers if the distributor so chooses. Using this data, the distributor can improve their internal logistics through more efficient deliveries and by enabling leaner on-hand inventory through more predictable customer usage. The distributor can offer inventory management as a feature to their customers, promising any tracked product will be delivered before it runs out, without requiring or in some cases, eliminating the need for personnel to check each site of usage.

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A method comprising:
providing a tracking unit, the tracking unit configured with a sensor, a microcontroller coupled to the sensor, and a transmitter coupled to the microcontroller;
collecting, by the microcontroller from the sensor, data of a good, the good associated with a user, the data of the good indicative of an amount of the good;
transmitting, by the transmitter, the data of the good through a device that relays the data of the good to a backend;
receiving, by the backend, the data of the good;
calculating, by the backend, a depletion rate of the good, a threshold value of the good, a depletion point, a predicted shipping time to receive the good and a reorder point wherein:
the depletion rate indicates a rate of consumption of the good by the user based on the data of the good;
the threshold value indicates an empty weight of the good;
the depletion point indicates a time when the good will be depleted based on the threshold value, the depletion rate and a current amount of the good;
the reorder point is based on the depletion point and the predicted shipping time to receive the good;
conducting, by the backend at the reorder point, a reverse auction request to a fulfillment source for a cost quote to order the good;
receiving, by the backend, the cost quote from the fulfillment source;
determining, by the backend, a lowest cost quote of the good; and
ordering, by the backend, the good on behalf of the user from the fulfillment source with the lowest cost quote.

2. The method of claim 1, wherein the tracking unit is coupled to the good and associated with the good before a sale of the good to the user.

3. The method of claim 1, wherein the tracking unit is coupled to an appliance and associated with the good in the appliance after a sale of the good.

4. The method of claim 1, wherein:
the tracking unit is coupled to a pad; and
the pad is capable of being associated with one or more goods after a sale of the good.

5. The method of claim 1, wherein the data of the good is a weight, volume, pressure, or count of the good.

6. The method of claim 1, further comprising:
transmitting, by the backend, an alert to the user if there is no change in the data of the good in a predetermined timeframe.

7. The method of claim 1, wherein the sensor is a pressure sensor or a strain gauge.

8. The method of claim 1, wherein a plurality of tracking units each having a different type of sensor collects the data of the good or the data of a plurality of goods.

9. The method of claim 1, wherein the transmitting of the data is by WiFi, Bluetooth or cellular technology.

10. The method of claim 1, wherein the device is a router, smartphone, hub or cellular network transceiver.

11. The method of claim 1, wherein a notification suggests alternative brands of the good to order with incentives for the fulfillment source.

12. The method of claim 11, wherein the incentives for the fulfillment source are a reduced referral fee or a cease of alternative brand suggestions.

13. The method of claim 1, wherein the reorder point is further based on a buffer, the buffer being a number of days based at least in part on the predicted shipping time or a weight indicating a minimum amount of the good above the empty weight.

14. A method comprising:
providing a tracking unit, the tracking unit configured with a sensor, a microcontroller coupled to the sensor, and a transmitter coupled to the microcontroller;
collecting, by the microcontroller from the sensor, data of a good, the good associated with a user, the data of the good indicative of an amount of the good;
transmitting, by the transmitter, the data of the good through a device that relays the data of the good to a backend;
receiving, by the backend, the data of the good;
calculating, by the backend from the data of the good, a depletion rate of the good, a threshold value of the good, a depletion point, a predicted shipping time to receive the good and a reorder point wherein:
the depletion rate indicates a rate of consumption of the good by the user based on the data of the good;
the threshold value indicates an empty weight of the good;
the depletion point indicates a time when the good will be depleted based on the threshold value, the depletion rate and a current amount of the good;
the reorder point is based on the depletion point and the predicted shipping time to receive the good;
transmitting, by the backend at the reorder point, a request to a fulfillment source for a cost quote to order the good; and
ordering, by the backend, the good on behalf of the user from the fulfillment source;
wherein the fulfillment source pays a premium.

15. The method of claim 14, wherein the premium is a fee.

16. The method of claim 14, wherein the tracking unit is coupled to the good and associated with the good before a sale of the good to the user.

17. The method of claim 14, wherein the tracking unit is coupled to an appliance and associated with the good in the appliance after a sale of the good.

18. The method of claim 14, wherein:
the tracking unit is coupled to a pad; and
the pad is capable of being associated with one or more goods after a sale of the good.

19. The method of claim 14, wherein the reorder point is further based on a buffer, the buffer being a number of days based at least in part on the predicted shipping time or a weight indicating a minimum amount of the good above the empty weight.

20. The method of claim 14, wherein a plurality of tracking units each having a different type of sensor collects the data of the good or the data of a plurality of goods.
